(19) United States
(12) Patent Application Publication
(10) Pub. No.: US 2024/0273402 A1
(43) Pub. Date: Aug. 15, 2024

(54) Artificial Intelligence (AI)-Based Generation of In-App Asset Variations

(71) Applicant: Sony Interactive Entertainment Inc., Tokyo (JP)

(72) Inventors: Victoria Dorn, Hayward, CA (US); Anders Lykkehoy, Foster City, CA (US); Michael Gibbes, Sunnyvale, CA (US)

(21) Appl. No.: 18/169,015

(22) Filed: Feb. 14, 2023

(51) Int. Cl. G06N 20/00

(52) U.S. Cl. CPC G06N 20/00

(57) ABSTRACT

A description of a reference version of an in-app asset is provided to an artificial intelligence model. A contextual communication is provided to the artificial intelligence model, wherein the contextual communication specifies a contextual feature for generation of variations of the reference version of the in-app asset. The artificial intelligence model is executed to automatically generate a variation of the in-app asset based on the contextual feature specified by the contextual communication, where the variation of the in-app asset is defined relative to the reference version of the in-app asset. The automatically generated variation of the in-app asset is conveyed for human assessment. In some embodiments, the automatically generated variation of the in-app asset is subjected to an automatic culling process before being conveyed for human assessment. In some embodiments, the in-app asset is defined by multiple layers. The in-app asset is either an audio asset or a graphical asset.

### BACKGROUND OF THE INVENTION

The video game industry has seen many changes over the years and has been trying to find ways to enhance the video game play experience for players and increase player engagement with the video games and/or online gaming systems. When a player increases their engagement with a video game, the player is more likely to continue playing the video game and/or play the video game more frequently, which ultimately leads to increased revenue for the video game developers and providers and video game industry in general. Therefore, video game developers and providers continue to seek improvements in video game operations to provide for increased player engagement and enhanced player experience. It is within this context that implementations of the present disclosure arise.

### SUMMARY OF THE INVENTION

In an example embodiment, a method is disclosed for automatically generating a variation of an in-app asset. The method includes providing a description of a reference version of an in-app asset to an artificial intelligence model. The method also includes providing a contextual communication to the artificial intelligence model. The contextual communication specifies a contextual feature for generation of variations of the reference version of the in-app asset. The method also includes executing the artificial intelligence model to automatically generate a variation of the in-app asset based on the contextual feature specified by the contextual communication. The method also includes conveying the variation of the in-app asset for human assessment.

In an example embodiment, a method is disclosed for training an artificial intelligence model for generation of a variation of an in-app asset. The method includes providing a reference version of an in-app asset as a training input to an artificial intelligence model. The method also includes providing a variation of the in-app asset as a training input to the artificial intelligence model. The method also includes providing a contextual communication as a training input to the artificial intelligence model. The contextual communication specifies a contextual feature used as a basis for generating the variation of the in-app asset from the reference version of the in-app asset. The method also includes adjusting one or more weightings between neural nodes within the artificial intelligence model to reflect changes made to the reference version of the in-app asset in order to arrive at the variation of the in-app asset in view of the contextual feature specified by the contextual communication.

In an example embodiment, a system for automatically generating and auditioning variations of an in-app asset is disclosed. The system includes an input processor configured to receive a reference version of an in-app asset and a contextual communication. The contextual communication specifies a contextual feature for generation of variations of the reference version of the in-app asset. The system also includes an artificial intelligence model configured to receive the reference version of the in-app asset and the contextual communication as input and automatically generate a variation of the in-app asset based on the reference version of the in-app asset and the contextual communication. The system also includes an output processor configured to convey the variation of the in-app asset to a client computing system.

### BRIEF DESCRIPTION OF THE DRAWINGS

FIG. 1 shows an example schema for defining a multi-layer in-app asset, in accordance with some embodiments.

FIG. 2 shows an example schema for a multi-layer audio in-app asset that provides sound for a door opening, in accordance with some embodiments.

FIG. 3 shows an example schema for a multi-layer graphical in-app asset that provides graphical images for a grassy region within a scene of a video game, in accordance with some embodiments.

FIG. 4 shows an example schema for a modified multi-layer in-app asset specification that may be for either an audio or graphical in-app asset, in accordance with some embodiments.

FIG. 5 shows a diagram of a tool for AI-driven automatic generation of variation of a multi-layer in-app asset for an input contextual specification, in accordance with some embodiments.

FIG. 6 shows an example AI model that implements a neural network for learning the intricacies of how to generate variations of multi-layer in-app assets (audio or graphical) based on specified contextual information, in accordance with some embodiments.

FIG. 7 shows a user interface provided by the output processor that can be used by the creator, e.g., sound designer/engineer, to audition (review and edit) the multi-layer audio in-app asset variations generated by the AI model, in accordance with some embodiments.

FIG. 8 shows a user interface provided by the output processor that can be used by the creator, e.g., graphic designer/engineer, to audition (review and edit) the multi-layer graphical in-app asset variations generated by the AI model, in accordance with some embodiments.

FIG. 9 shows a flowchart of a method for automatically generating a variation of an in-app asset, in accordance with some embodiments.

FIG. 10 shows a flowchart of a method for training the AI model for generation of a variation of an in-app asset, in accordance with some embodiments.

FIG. 11A is a general representation of an image generation AI (IGAI) processing sequence, in accordance with some embodiments.

FIG. 11B illustrates additional processing that may be done to the input, in accordance with some embodiments.

FIG. 11C illustrates how the output of the encoder is then fed into latent space processing, in accordance with some embodiments.

FIG. 12 illustrates components of an example server device within a cloud-based computing system that can be used to perform aspects of the tool, in accordance with some embodiments.

### DETAILED DESCRIPTION OF THE INVENTION

In the following description, numerous specific details are set forth in order to provide a thorough understanding of the present disclosure. It will be apparent, however, to one skilled in the art that embodiments of the present disclosure may be practiced without some or all of these specific details. In other instances, well known process operations have not been described in detail in order not to unnecessarily obscure the present disclosure.

Many modern computer applications, such as video games, virtual reality applications, augmented reality applications, virtual world applications, etc., generate immersive virtual environments in which the user of the app is virtually surrounded by various visual objects and sounds. Many such applications also strive to achieve a maximum level of realism, so that the user feels a greater sense of alternative reality when executing the application. Of course, the real world is incredibly complex in its diversity of content and with its essentially infinite number of variations on almost every perceivable object. Therefore, it is no small challenge to create computer applications that satisfy natural human expectations with regard to what constitutes an acceptable minimum level of realism in virtual reality. In particular, when it comes to increasing the level of realism in computer applications, it is often necessary to create many variations of a given in-app asset in order to increase the diversity and variation of what is perceived by the user of the computer application. For example, if the computer application presents a virtual scene in which the user is walking through a meadow, it would be better for the sake of improved realism to have many different variations of relevant graphical in-app assets, such as graphics and animations for flowers, grasses, insects, etc. Similarly, the realism of the virtual scene in which the user is walking through a meadow would benefit from having many different variations of relevant sounds, such a grass sounds, walking sounds, wind sounds, insect sounds, etc. The generation of multiple variations of in-app graphical assets and in-app audio assets requires a tremendous amount of creative/design work, which corresponds to increased application development expense and longer application production schedules. Therefore, in this regard, various embodiments are disclosed herein for leveraging AI technology to improve the efficiency with which variations of audio and/or graphical in-app assets can be developed and assessed for use in computer applications.

The term computer application as used herein refers to essentially any type of computer application in which graphics and/or sounds are presented to a user of the computer application, particularly where the context of the computer application benefits from having multiple variations of a given graphic and/or a given sound. In some embodiments, the computer application is executed on a cloud computing system and the associated video and audio stream is transmitted over the Internet to a client computing system. In some embodiments, the computer application is executed locally on the client computing system. In some embodiments, the computer application is executed on both the cloud computing system and the local client computing system. In some embodiments, the computer application is a video game. In some embodiments, the computer application is a virtual reality application. In some embodiments, the computer application is an augmented reality application. In some embodiments, the computer application is a virtual world application. However, it should be understood that the systems and methods disclosed herein for leveraging AI technology to improve the efficiency with which variations of audio and/or graphical in-app assets are developed and assessed can be used with essentially any computer application that may benefit from having such variations of audio and/or graphical in-app assets.

The term in-app asset as used herein refers to any audio and/or graphical content within a computer application. In some embodiments, the in-app asset is an audio file. In various embodiments, the audio file includes one or more of a computer generated sound and an audio recording. In some embodiments, the audio in-app asset is associated with a graphical in-app asset, as if the audio in-app asset is emanating from the graphical in-app asset. In some embodiments, the in-app asset is a graphical object within a computer application. In various embodiments, the graphical in-app asset is one or more of a computer generated graphic, a computer generated video, a captured image, and a recorded video. In some embodiments, the graphical in-app asset is a computer generated animated graphic in which a particular movement or dynamism is imparted to a computer generated graphical image. The actual audible content of the audio in-app asset and the actual visual content of the graphical in-app asset are dependent upon the computer application in which they occur and can, therefore, be essentially any type of sound and essentially any type of visual depiction, respectively.

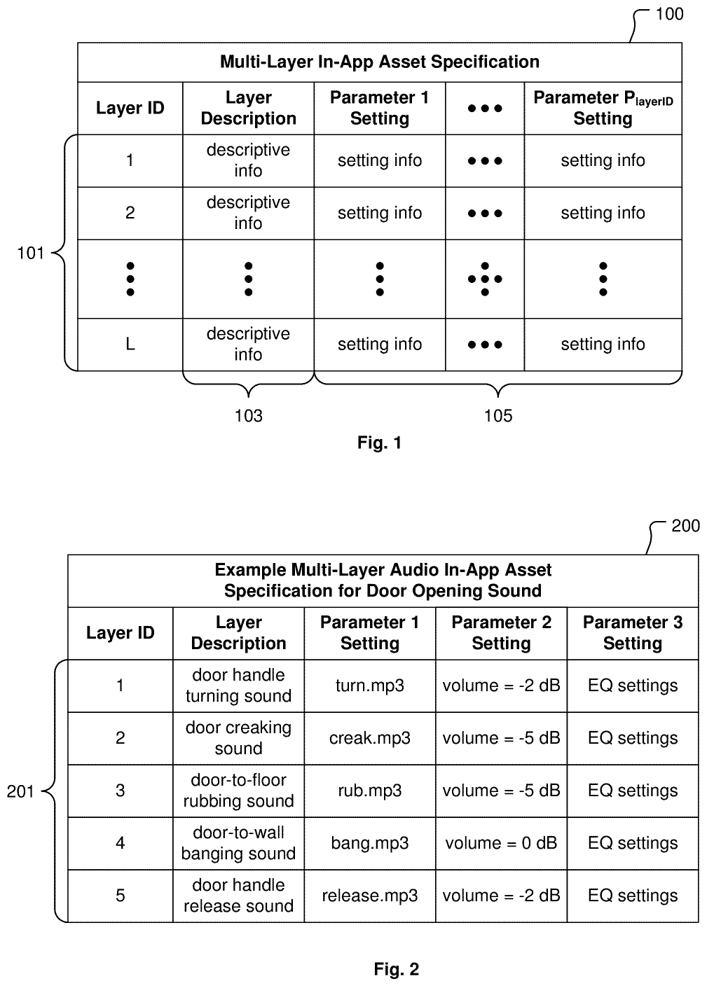

In some embodiments, the in-app asset, whether audio or graphical, is defined as a multi-layer in-app asset in which each different layer is specified to define some attribute of the in-app asset, with all of the different layers presented/applied in combination to convey the in-app asset within the computer application. FIG. 1 shows an example schema 100 for defining a multi-layer in-app asset, in accordance with some embodiments. The schema 100 shows that the multi-layer in-app asset includes a number (L) of layers 101. Each layer 101 defines a particular feature or characteristic of the in-app asset. In some embodiments, each layer 101 of the schema 100 includes a layer description 103 that identifies the relevance of the layer 101 to the in-app asset. In some embodiments, each layer 101 of the schema 100 includes parameter settings 105 for a number of parameters (P_{layerID}) that define some part of the in-app asset, where the number of parameters P_{layerID} specified by a given layer 101 is greater than or equal to one. It should be understood that each layer 101 can have either the same number of parameters (P_{layerID}) or a different number of parameters (P_{layerID}). Also, it should be understood that the parameters that define a given layer 101 of the in-app asset can be either the same as or different than the parameters that define other layers 101 of the in-app asset. The parameters that define a given layer 101 of the in-app asset are referred to as the metadata for the given layer 101.

FIG. 2 shows an example schema 200 for a multi-layer audio in-app asset that provides sound for a door opening, in accordance with some embodiments. This example audio in-app asset is defined by 5 layers 201, including a layer 1 for a door handle turning sound, a layer 2 for a door creaking sound, a layer 3 for a door-to-floor rubbing sound, a layer 4 for a door-to-wall banging sound, and a layer 5 for a door handle release sound. Each layer of this particular example, includes a Parameter 1 setting for the reference sound filename, a Parameter 2 setting for volume, and a Parameter 3 setting for equalization (EQ) settings. It should be appreciated that in other example embodiments, any of the layers of the example of FIG. 2 can include more or less audio parameter settings, such as filters, attenuators, reverb, oscillators, or any other audio parameter know in the art of sound design. Also, it should be understood that in other example embodiments, the door opening audio in-app asset of FIG. 2 can include either less or more than the five example layers. It should be understood that the example schema 200 of FIG. 2 is provided by way of example to illustrate the process of defining a multi-layer audio in-app asset, but the example schema 200 of FIG. 2 does not in any way place any limitations on how other multi-layer audio in-app assets can be defined.

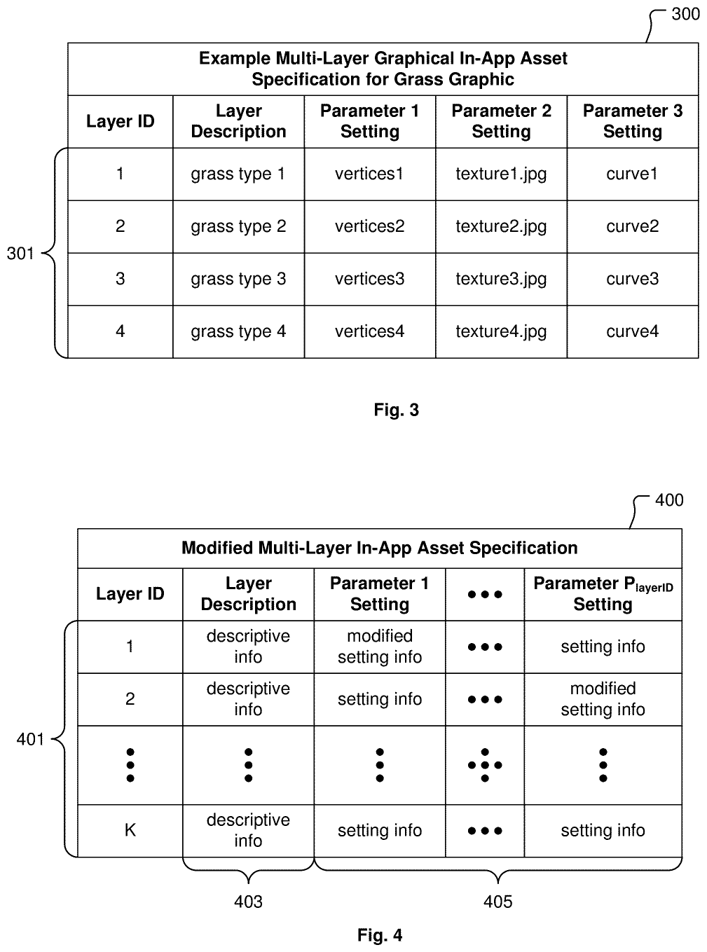

FIG. 3 shows an example schema 300 for a multi-layer graphical in-app asset that provides graphical images for a grassy region within a scene of a video game, in accordance with some embodiments. This example graphical in-app asset is defined by four layers 301, including a layer 1 for a first grass type, a layer 2 for a second grass type, a layer 3 for a third grass type, and a layer 4 for a fourth grass type. Each layer of this particular example, includes a Parameter 1 setting for the grass blade vertex specifications, a Parameter 2 setting for the grass blade texture specifications, and a Parameter 3 setting for the grass blade curvature specifications. It should be appreciated that in other example embodiments, any of the layers of the example of FIG. 3 can include more or less graphical parameter settings, such as filters, color adjustments, shadow adjustments, animation parameters, or any other graphical parameter known in the art of graphic design. Also, it should be understood that in other example embodiments, the grassy region graphical in-app asset of FIG. 3 can include either less or more than the four example layers. It should be understood that the example schema 300 of FIG. 3 is provided by way of example to illustrate the process of defining a multi-layer graphical in-app asset, but the example schema 300 of FIG. 3 does not in any way place any limitations on how other multi-layer graphical in-app assets can be defined.

For some computer applications, it is of interest to have multiple variations of a given in-app asset (whether audio or graphical) in order to improve the user experience of the computer application, such as by improving the variety and/or realism of audio and graphical content that is conveyed by the computer application to the user. In some design studios, an audio engineer/designer or a graphics engineer/designer will either obtain or create a reference multi-layer in-app asset specification and then proceed to manually create multiple variations of the reference multi-layer in-app asset. FIG. 4 shows an example schema 400 for a modified multi-layer in-app asset specification that may be for either an audio or graphical in-app asset, in accordance with some embodiments. The example schema 400 includes a number (K) of layers 401 for defining the modified multi-layer in-app asset. The number (K) of layers 401 for the modified multi-layer in-app asset can be either the same as or different than the number of layers that define the reference multi-layer in-app asset upon which the modified multi-layer in-app asset is based. In some embodiments, each layer 401 of the schema 400 includes a layer description 403 that identifies the relevance of the layer 401 to the in-app asset. In some embodiments, each layer 401 of the schema 400 includes parameter settings 405 for a number of parameters (P_{layerID}) that define some part of the in-app asset, where the number of parameters P_{layerID} specified by a given layer 401 is greater than or equal to one.

In some embodiments, the modified multi-layer in-app asset can be defined in-part by removing one or more layers that define the reference multi-layer in-app asset upon which the modified multi-layer in-app asset is based. In some embodiments, the modified multi-layer in-app asset can be defined in-part by adding one or more layers to the layers that define the reference multi-layer in-app asset upon which the modified multi-layer in-app asset is based. In some embodiments, the modified multi-layer in-app asset can be defined in-part by modifying one or more layers that define the reference multi-layer in-app asset upon which the modified multi-layer in-app asset is based. In various embodiments, the layer modification is done by one or more of: changing a setting of one or more parameter(s) for defining the layer, removing one or more parameter(s) for defining the layer, and adding one or more parameter(s) for defining the layer.

In some computer applications, such as video games, the computer application needs to make a lot of sounds. Many of the sounds in these computer applications are variations on sounds that have already been created. As previously discussed, a given sound can be defined as a multi-layer in-app asset, where each layer provides some variation to the sound. Creating all of the variations of a given sound takes a lot of sound creator time. For example, the sound creator will create a reference sound. Then, the sound creator has to spend a lot of time creating variations of the reference sound. The variations on the reference sound can be created by combining multiple layers of sounds, and/or by adjusting sound parameters, such as the EQ, filter, reverb, oscillator, attenuator, compressor, and/or any other sound parameter or effect. The bottom line is that it takes a lot of time and tedious work to create many layers for a given reference sound or modification thereof. The same issue applies to creation of a given reference graphic or modification thereof.

It could be boring from a user perspective for some computer applications to have the same sounds and/or graphics used over and over. To improve realism of the sounds and graphics within the computer application, and correspondingly improve the user's experience of the computer application, it is of interest to have a wider variety of sound and graphics available for use in the computer application. However, as just mentioned, creation of a wider variety of sounds and/or graphics requires a significant amount of creative work/time. Therefore, it is of interest to have a tool that will take as input a reference multi-layer in-app asset, including all of the metadata for the multiple layers, and automatically generate variations of the multi-layer in-app asset based on some contextual specification. Along these lines, systems and methods are disclosed herein for using an AI model to automatically generate variations of a reference multi-layer in-app asset for a given contextual specification.

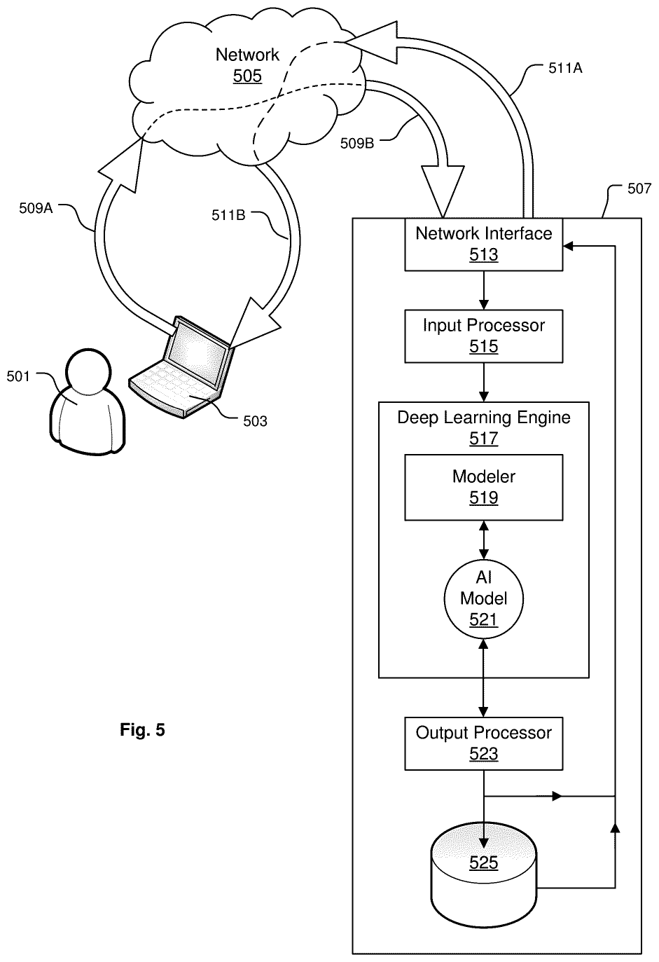

FIG. 5 shows a diagram of a tool 507 for AI-driven automatic generation of variation of a multi-layer in-app asset for an input contextual specification, in accordance with some embodiments. In some embodiments, the tool 507 is used to automatically generate variations of an audio in-app asset. In some embodiments, the tool 507 is used to automatically generate variations of a graphical in-app asset. In some embodiments, a creator 501, e.g., a sound designer/engineer or graphical designer/engineer, working at a client computing system 503 provides a reference multi-layer in-app asset and all of its layer metadata as input to the tool 507, by way of a network 505, e.g., Internet, as indicated by arrows 509A and 509B. For example, the creator 501 provides one or more reference audio file(s) and corresponding layer metadata for a multi-layer audio in-app asset as input to the tool 507. In another example, the creator 501 provides one or more reference graphical file(s) and corresponding layer metadata for a multi-layer graphical in-app asset as input to the tool 507. The creator 501 also provides a contextual communication as input to the tool 507. The contextual communication specifies a contextual feature for generation of variations of the reference version of the multi-layer in-app asset. More specifically, the tool 507 is configured to automatically create variations of the reference multi-layer in-app asset that was provided as input to the tool 507, with the created variations corresponding in some way to the contextual feature conveyed in the contextual communication that was provided as input to the tool 507.

In some embodiments, the tool 507 is set to create variations on the layers of the multi-layer in-app asset that is initially provided as input to the tool 507. In some embodiments, the tool 507 is set to allow removal of one or more of the layers of the multi-layer in-app asset that is initially provided as input to the tool 507. In some embodiments, the tool 507 is set to allow addition of one or more layers to the multi-layer in-app asset that is initially provided as input to the tool 507. In some embodiments, the tool 507 is set to allow both removal of one or more layers from and addition of one or more layers to the multi-layer in-app asset that is initially provided as input to the tool 507. It should be understood that the tool 507 can create variations on the layers of the multi-layer in-app asset that is initially provided as input to the tool 507 in combination with removal and/or addition of one or more layers from/to the multi-layer in-app asset that is initially provided as input to the tool 507. In some embodiments, the tool 507 provides the creator 501 with the option of specifying that certain layers of the multi-layer in-app asset that is initially provided as input to the tool 507 be retained as the tool 507 automatically generates the variations on the input multi-layer in-app asset.

In some embodiments, the tool 507 is configured to provide, as output to the creator 501, the one or more multi-layer in-app asset specifications and corresponding metadata that were automatically generated by the tool 507 from the input reference multi-layer in-app asset and all of its layer metadata in conjunction with the input contextual communication. The output of the tool 507 is conveyed from the tool 507 through the network 505 to the client computing system 503 of the creator 501, as indicated by arrows 511A and 511B. In some embodiments, where the input reference multi-layer in-app asset is an audio in-app asset, the output of the tool 507 is provided to the creator 501 as digital audio workstation (DAW) project file. In some embodiments, where the input reference multi-layer in-app asset is a graphical in-app asset, the output of the tool 507 is provided to the creator 501 as one or more graphics files including the associated metadata.

In some embodiments, the tool 507 includes a network interface 513 configured to receive and process incoming data communication signals/packets and prepare and transmit outgoing data communication signals/packets. In various embodiments, the network interface 513 is configured to operate in accordance with any known network/Internet protocol for data communication. In some embodiments, the tool 507 includes an input processor 515. The input processor 515 is configured to receive input from the creator 501 by way of the network interface 513. The input processor 515 operates to format the received input for provision as input to a deep learning engine 517. In some embodiments, the input includes a reference multi-layer in-app asset (audio or graphical) including associated metadata for the various layers, along with a contextual communication that specifies a contextual feature for use in generating variations of the reference multi-layer in-app asset.

In some embodiments. the tool 507 includes the deep learning engine 517, which includes an AI modeler 519 and an AI model 521. The modeler 519 is configured to build and/or train the AI model 521 using training data. In various embodiments, deep learning (also referred to as machine learning) techniques are used to build the AI model 521 for use in generation of variations of multi-layer in-app assets for a specified context. In various embodiments, the AI model 521 is built and trained based on training data that includes volumes of reference multi-layer in-app asset specifications and validated modifications of the reference multi-layer in-app asset specifications, along with corresponding contextual communication data. For example, a creator's 501 multi-layer in-app asset design library, including creator-developed variations of different reference multi-layer in-app assets for various contexts, can be used as training data for the AI model 521. It should be understood that in different embodiments the AI model 521 can be trained for either audio in-app asset generation or graphical in-app asset generation. In some embodiments, the AI model 521 is trained based on some success criteria (e.g., creator 501 approval), such as following one path over another similar path through the AI model 521 that is more successful in terms of the success criteria. In some embodiments, the success criteria is validation/approval of a generated multi-layer in-app asset by the creator 501. In this manner, the AI model 521 learns to take the more successful path. The training data for the AI model 521 can include metadata associated with the creator's 501 development of variations of multi-layer in-app assets for a given contextual specification. In various embodiments, the training data for the AI model 521 includes any data that is relevant to understanding how the creator 501 would go about creating variations of multi-layer in-app assets for a given contextual specification. The AI model 521 is continually refined through the continued collection of training data, and by comparing new training data to existing training data to facilitate use of the best training data based on the success criteria. Once the AI model 521 is sufficiently trained, the AI model 521 can be used to automatically generate multi-layer in-app assets that are variations of a reference multi-layer in-app asset based on one or more specified contextual feature(s).

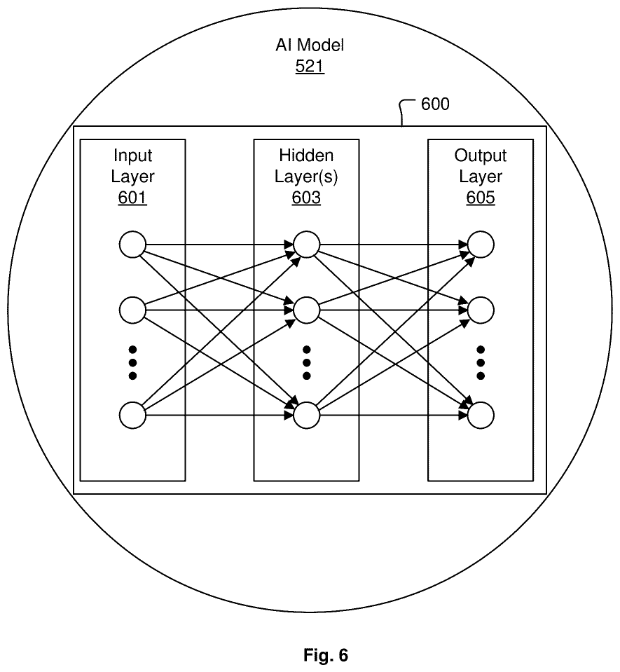

FIG. 6 shows an example AI model 521 that implements a neural network 600 for learning the intricacies of how to generate variations of multi-layer in-app assets (audio or graphical) based on specified contextual information, in accordance with some embodiments. Given an input defined as a reference multi-layer in-app asset along with its layer metadata and a contextual feature specification, the AI model 521 can analyze the input and provide an appropriate response to the input. For example, the AI model 521 can be used to generate variations of the reference multi-layer in-app asset that have some relevance to the specified contextual feature. The modeler 519 is configured to build the AI model 521 as needed to learn about the multi-layer in-app asset generation process for a given context. In various embodiments, the deep learning engine 517 utilizes AI, including deep learning algorithms, reinforcement learning, or other AI-based algorithms to build and train the AI model 521. The deep learning engine 517 may be configured to continually refine the trained AI model 521 given any updated training data. More particularly, during the learning and/or modeling phase, the training data is used by the deep learning engine 517 to learn how a creator (e.g., sound designer or graphic designer) or group of creators create variations of a given multi-layer in-app asset for a specified context.

In some embodiments, training of the AI model 521 is based on an audio library (sound design portfolio) of a given sound designer, or on a given sound effect library of the given sound designer, or on a particular sound effect that the given sound designer likes to use. In some embodiments, the AI model 521 is trained to learn a particular sound designer's preferences with regard to sound layer creation. A similar approach is used for graphics. For example, a graphic designer's preferred variation on color data can be used to train the AI model 521. It should be understood that many variations of a given multi-layer in-app asset are input into the AI model 521 to train the AI model 521. In this manner, the AI model 521 learns how to create variations of a particular multi-layer in-app asset. Once trained, the AI model 521 can be used to automatically generate contextually-influenced variations of an arbitrary reference multi-layer in-app asset that is provided to the AI model 521 as an input.

In various embodiments, the neural network 600 can be implemented as a deep neural network, a convolutional deep neural network, and/or a recurrent neural network using supervised or unsupervised training. In some embodiments, the neural network 600 includes a deep learning network that supports reinforcement learning, or rewards based learning (e.g., through the use of success criteria, success metrics, etc.). For example, in some embodiments, the neural network 600 is set up as a Markov decision process (MDP) that supports a reinforcement learning algorithm.

The neural network 600 represents a network of interconnected nodes, such as an artificial neural network. In FIG. 6, each circle represents a node. Each node learns some information from the training data. Knowledge can be exchanged between the nodes through the interconnections. In FIG. 6, each arrow between nodes represents an interconnection. Input to the neural network 600 activates a set of nodes. In turn, this set of nodes activates other nodes, thereby propagating knowledge about the input. This activation process is repeated across other nodes until an output is provided. The example neural network 600 includes a hierarchy of nodes. At the lowest hierarchy level, an input layer 601 exists. The input layer 601 includes a set of input nodes. For example, in some embodiments, each of the input nodes of the input layer 601 is mapped to a corresponding instance of a multi-layer in-app asset for a particular contextual feature, where the corresponding instance is defined by multiple layer and corresponding metadata. In some embodiments, intermediary predictions of the AI model 521 are determined through a classifier that creates labels, such as outputs, features, nodes, classifications, etc. At the highest hierarchical level, an output layer 605 exists. The output layer 605 includes a set of output nodes. Each output node represents a variation of a reference multi-layer in-app asset for a given contextual feature that relates to one or more components of the trained AI model 521. In various embodiments, the output nodes of the output layer 605 may identify the predicted or expected changes made to the reference multi-layer in-app asset in order to arrive at a potentially usable variation of the reference multi-layer in-app asset for a given context. The results predicted by the AI model 521 can be compared to pre-determined and true results, or learned changes and results, as obtained from the creator 501 in order to refine and/or modify the parameters used by the deep learning engine 517 to iteratively determine the appropriate predicted or expected responses and/or changes for a given set of inputs. The nodes in the neural network 600 learn the parameters of the trained AI model 521 that can be used to make such decisions when refining the parameters.

In some embodiments, one or more hidden layer(s) 603 exists within the neural network 600 between the input layer 601 and the output layer 605. The hidden layer(s) 603 includes “X” number of hidden layers, where “X” is an integer greater than or equal to one. Each of the hidden layer(s) 603 includes a set of hidden nodes. The input nodes of the input layer 601 are interconnected to the hidden nodes of first hidden layer 603. The hidden nodes of the last (“X^{th}”) hidden layer 603 are interconnected to the output nodes of the output layer 605, such that the input nodes are not directly interconnected to the output nodes. If multiple hidden layers 603 exist, the input nodes of the input layer 601 are interconnected to the hidden nodes of the lowest (first) hidden layer 603. In turn, the hidden nodes of the first hidden layer 603 are interconnected to the hidden nodes of the next hidden layer 603, and so on, until the hidden nodes of the highest (“X^{th}”) hidden layer 603 are interconnected to the output nodes of the output layer 605.

An interconnection connects two nodes in the neural network 600. The interconnections in the example neural network 600 are depicted by arrows. Each interconnection has a numerical weight that can be learned, rendering the neural network 600 adaptive to inputs and capable of learning. Generally, the hidden layer(s) 603 allow knowledge about the input nodes of the input layer 601 to be shared among all the tasks corresponding to the output nodes of the output layer 605. In this regard, in some embodiments, a transformation function ƒ is applied to the input nodes of the input layer 601 through the hidden layer(s) 603. In some cases, the transformation function ƒ is non-linear. Also, different non-linear transformation functions ƒ are available including, for instance, a rectifier function ƒ(x)=max(0,x).

In some embodiments, the neural network 600 also uses a cost function c to find an optimal solution. The cost function c measures the deviation between the prediction that is output by the neural network 600 defined as ƒ(x), for a given input x and the ground truth or target value y (e.g., the expected result). The optimal solution represents a situation where no solution has a cost lower than the cost of the optimal solution. An example of a cost function c is the mean squared error between the prediction and the ground truth, for data where such ground truth labels are available. During the learning process, the neural network 600 can use back-propagation algorithms to employ different optimization methods to learn model parameters (e.g., learn the weights for the interconnections between nodes in the hidden layer(s) 603) that minimize the cost function c. An example of such an optimization method is stochastic gradient descent.

In some embodiments, the tool 507 includes an output processor 523. In various embodiments, the output processor 523 is configured to receive the output generated by the deep learning engine 517 and prepare the output for transmission to the creator 501 by way of the network interface 513 and/or for storage in a data store 525. In some embodiments, the data store 525 is also used for storing data associated with operation of the tool 507. It should be understood that the data store 525 can be either part of the tool 507, or can be cloud data storage system that is accessible by the tool 507 over the network 505, or can be essentially any other type of data storage that is accessible by the tool 507.

In some embodiments, there is a chance that some of the multi-layer in-app asset variations generated by the AI model 521 may be outside of acceptable parameters. For example, a multi-layer audio in-app asset variation generated by the AI model 521 could have some detectable audio distortion or be an outlier on equalization or frequency response. Similar types of outliers may also occur with regard to graphical in-app asset variations generated by the AI model 521. Therefore, in some embodiments, the output processor 523 is configured to implement an auto-culling process on the multi-layer in-app asset variations generated by the AI model 521, such that obviously unusable in-app asset variations are discarded. In some embodiments, in the case of multi-layer audio in-app asset variation generation, an objective audio quality analysis tool is used by the output processor 523 to procedurally discard and/or flag multi-layer audio in-app asset variations generated by the AI model 521 that fall outside of some specified audio acceptance criteria. Similarly, in some embodiments, in the case of multi-layer graphical in-app asset variation generation, an objective graphical quality analysis tool is used by the output processor 523 to procedurally discard and/or flag multi-layer graphical in-app asset variations generated by the AI model 521 that fall outside of some specified graphical acceptance criteria.

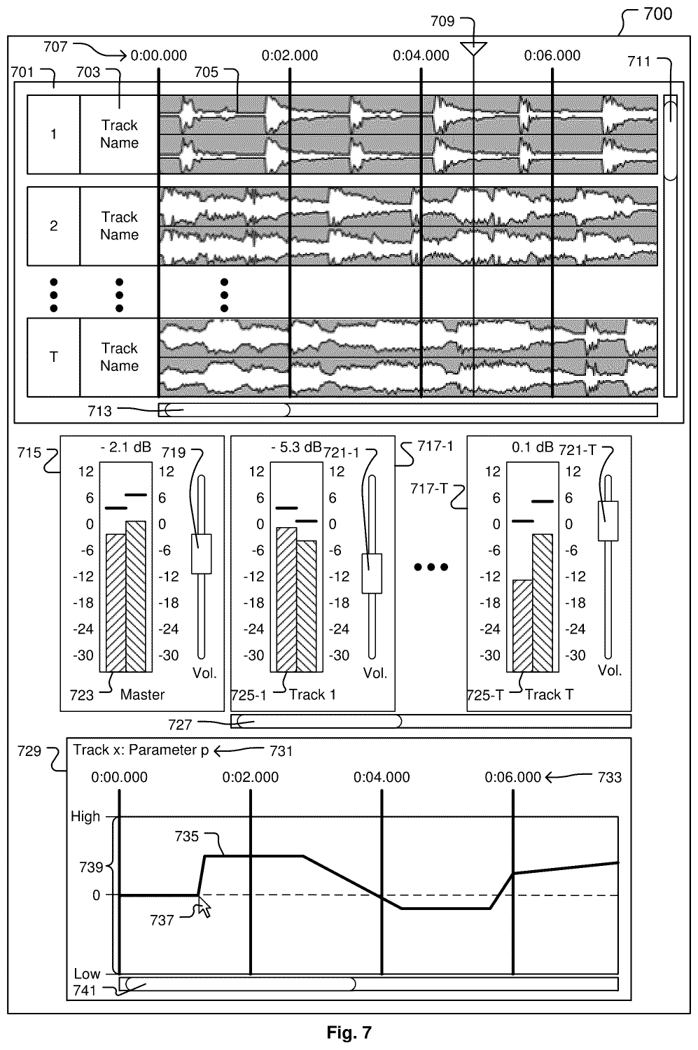

In some embodiments, the output processor 523 is configured to provide a user interface through which the creator 501 can review and edit the multi-layer in-app asset variations generated by the AI model 521. For example, FIG. 7 shows a user interface 700 provided by the output processor 523 that can be used by the creator 501, e.g., sound designer/engineer, to audition (review and edit) the multi-layer audio in-app asset variations generated by the AI model 521, in accordance with some embodiments. In some embodiments, the user interface 700 presents a track review interface 701 in which a number (T) of audio tracks for corresponding AI-generated multi-layer audio in-app asset variations are presented for selection and playback by the creator 501. In some embodiments, each of the T tracks is identified by a track name 703 and has its corresponding audio waveform 705 presented along a time line 707. In some embodiments, a current playback time 709 is presented to move along the time line 707, and is manually positionable by the creator 501 along the time line 707. In some embodiments, a horizontal scroll bar 713 is provided to enable scrolling through the T audio tracks along the time line 707. In some embodiments, a vertical scroll bar 711 is provided to enable scrolling through the listing of the T audio tracks. It should be understood that the track review interface 701 is provided by way of example. In other embodiments, the track review interface 701 can be configured in essentially any manner that provides for creator 501 review of the multi-layer audio in-app asset variations as generated by the AI model 521.

Also, in some embodiments, the user interface 700 provided by the output processor 523 includes tools to enable manual adjustment of any of the T audio tracks by the creator 501. For example, in some embodiments, a master volume control panel 715 is provided and includes a master volume control 719 that provides for control of a master volume across all T audio tracks. The master volume control 719 includes a volume meter 723 that shows the volume levels in real time for each track current played. Also, in some embodiments, the user interface 700 includes individual audio track volume control panels 717-1 through 717-T for the T audio tracks, respectively. Each individual audio track volume control panel 717-1 through 717-T includes a respective individual audio track volume control 721-1 through 721-T. Also, each individual audio track volume control panel 717-1 through 717-T includes a respective volume meter 725-1 through 725-T that shows the volume level in real time for the corresponding audio track. A scroll bar 727 is provided to enable scrolling through the individual audio track volume control panels 717-1 through 717-T. It should be understood that the volume control portion of the user interface 700 is provided by way of example. In other embodiments, the user interface 700 can be configured in essentially any manner that provides for creator 501 control of the volumes of the various T audio tracks.

Also, in some embodiments, the user interface 700 includes an audio parameter review and adjustment control panel 729 that provides for display and adjustment of an audio parameter p for track x, as indicated by the heading 731. A plot 735 of the audio parameter p setting is shown graphically as a function of time along the track playback timeline 733. In some embodiments, the audio parameter p setting is defined on a scale 739 that extends between a minimum value (min) and a maximum value (max). A scroll bar 741 is provided to enable scrolling of the plot 735 of the audio parameter p setting along the track playback timeline 733. In some embodiments, the creator 501 is able to adjust the audio parameter p setting at any point along the plot 735 by using a cursor 737 to click and drag the plot 735 of the audio parameter p setting to any desired value at any temporal location along the track playback timeline 733. In various embodiments, the audio parameter p depicted by the plot 735 can be any audio control parameter or effect for which a value is specified as a function of time along the track playback timeline 733. It should be understood that the audio parameter review and adjustment control panel 729 is provided by way of example. In other embodiments, the user interface 700 can be configured in essentially any manner that provides for creator 501 control of any audio parameter for each of the various T audio tracks.

Through the user interface 700, the creator 501 is able to select which of the AI-generated multi-layer in-app audio asset variations are to be retained or discarded. Also, in some embodiment, the user interface 700 provides for flagging of AI-generated multi-layer audio in-app asset variations that are questionable with regard to usability. It should be understood that through the user interface 700, the creator 501 is able to review the multi-layer audio in-app asset variations generated by the AI model 521 to determine which variations are actually of interest for use. In some embodiment, the output processor 523 is configured to output the AI-generated multi-layer audio in-app asset variations as a digital audio workstation (DAW) file that can be opened by a DAW for creator 501 review and adjustment. In some embodiments, decisions made by the creator 501 on which of the AI-generated multi-layer audio in-app asset variations are good or bad are fed back into the deep learning engine 517 to further refine the AI model 521 by way of the modeler 519. Also, in some embodiments, changes made by the creator 501 to the AI-generated multi-layer audio in-app asset variations through either the user interface 700 of through a DAW are fed back into the deep learning engine 517 to further refine the AI model 521 by way of the modeler 519.

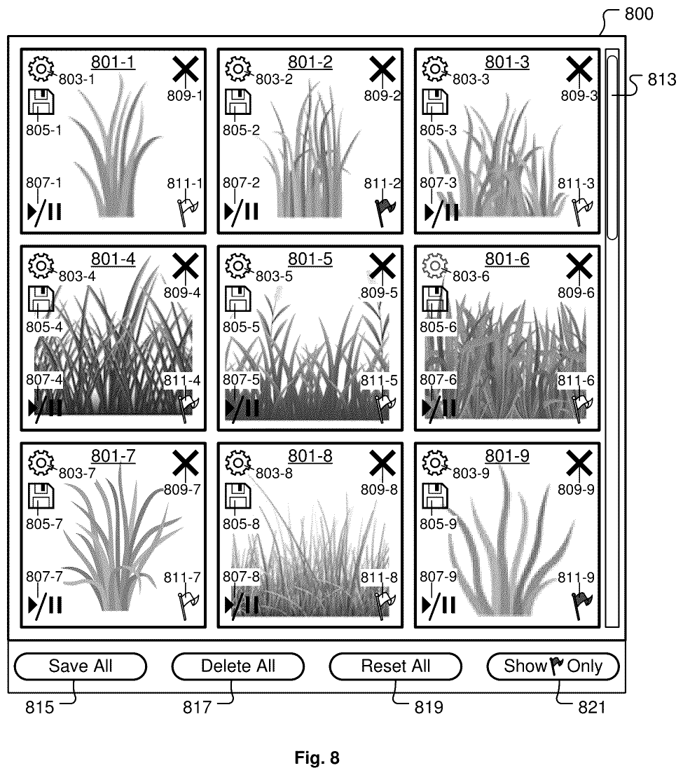

FIG. 8 shows a user interface 800 provided by the output processor 523 that can be used by the creator 501, e.g., graphic designer/engineer, to audition (review and edit) the multi-layer graphical in-app asset variations generated by the AI model 521, in accordance with some embodiments. The example of FIG. 8 shows multi-layer graphical in-app asset variations for a grassy area within a scene of a computer application, as generated by the AI model 521. Each AI-generated multi-layer graphical in-app asset variation is visually shown in a respective review block 801-1 through 801-9. A scroll bar 813 is provided to enable navigation by the creator 501 through many multi-layer graphical in-app asset variations generated by the AI model 521. Each review block 801-1 through 801-9 includes a control icon 803-1 through 803-9, respectively, that when selected by the creator 501 will open a display that shows the various layers and graphical settings for the corresponding AI-generated multi-layer graphical in-app asset variation, such as shown in the example schema 400 of FIG. 4. In some embodiments, the creator 501 is able to make adjustments to graphical control parameters directly in the display that is shown in response to selection of the control icon 803-1 through 803-9.

In some embodiments, each review block 801-1 through 801-9 includes a remove icon 809-1 through 809-9, respectively, that when selected by the creator 501 will cause the corresponding AI-generated multi-layer graphical in-app asset variation to be removed/deleted. In some embodiments, each review block 801-1 through 801-9 includes a save icon 805-1 through 805-9, respectively, that when selected by the creator 501 will cause the corresponding AI-generated multi-layer graphical in-app asset variation to be saved to the data store 525. In some embodiments, each review block 801-1 through 801-9 includes a flag icon 811-1 through 811-9, respectively, that when selected by the creator 501 will cause the corresponding AI-generated multi-layer graphical in-app asset variation to be flagged for subsequent processing. For example, FIG. 8 shows that the AI-generated multi-layer graphical in-app asset variations in review blocks 801-2 and 801-9 have their flag icons 811-2 and 811-9, respectively, selected. Also, in some embodiments, one or more of the multi-layer graphical in-app asset variations generated by the AI model 521 are animated. In some embodiments, each review block 801-1 through 801-9 includes a play/pause icon 807-1 through 807-9, respectively, that when selected by the creator 501 will cause the animation of the corresponding AI-generated multi-layer graphical in-app asset variation to play and pause in a toggled manner.

Also, in some embodiments, the user interface 800 includes some global controls, including a save all control 815, a delete all control 817, a reset all control 819, and a show flagged only control 821. Selection of the save all control 815 by the creator 501 will cause all of the currently displayed AI-generated multi-layer graphical in-app asset variations to be saved to the data store 525. Selection of the delete all control 817 by the creator 501 will cause all of the currently displayed AI-generated multi-layer graphical in-app asset variations to be deleted. Selection of the reset all control 819 by the creator 501 will cause all of the AI-generated multi-layer graphical in-app asset variations to be restored to their original formats as output by the AI model 521. Selection of the show flagged only control 821 will cause display of only those AI-generated multi-layer graphical in-app asset variations that have their flag icons 811-1 through 811-9 set to flagged. For example, selection of the show flagged only control 821 in FIG. 8 will cause display of only the AI-generated multi-layer graphical in-app asset variations in review blocks 801-2 and 801-9. It should be understood that the user interface 800 is provided by way of example. In other embodiments, the user interface 800 can be configured in essentially any manner that provides for creator 501 review and adjustment of the multi-layer graphical in-app asset variations as generated by the AI model 521. Also, it should be understood that the output processor 523 is configured to output the AI-generated multi-layer graphical in-app asset variations as a graphics file that can be opened within a graphics development platform for creator 501 review and adjustment.

In some embodiments, the tool 507 is a system for automatically generating and auditioning variations of an in-app asset. The system includes the input processor 515 configured to receive a reference version of an in-app asset and a contextual communication. The contextual communication specifies a contextual feature for generation of variations of the reference version of the in-app asset. The system includes the AI model 521 configured to receive the reference version of the in-app asset and the contextual communication as input and automatically generate a variation of the in-app asset based on the reference version of the in-app asset and the contextual communication. The system also includes the output processor 523 configured to convey the variation of the in-app asset to the client computing system 503. In some embodiments, the in-app asset is defined by multiple layers, where each of the multiple layers defines a different aspect of the in-app asset. In some embodiments, the variation of the in-app asset includes a different set of layers as compared to a reference set of layers that define the reference version of the in-app asset and/or at least one different parameter setting within a layer common to both the reference version of the in-app asset and the variation of the in-app asset. In some embodiments, the system also includes a graphical user interface, e.g., 700 and/or 800, executed at the client computing system 503 to provide for rendering and assessment of the AI-generated variation of the in-app asset. In some embodiments, the in-app asset is either an audio asset or a graphical asset.

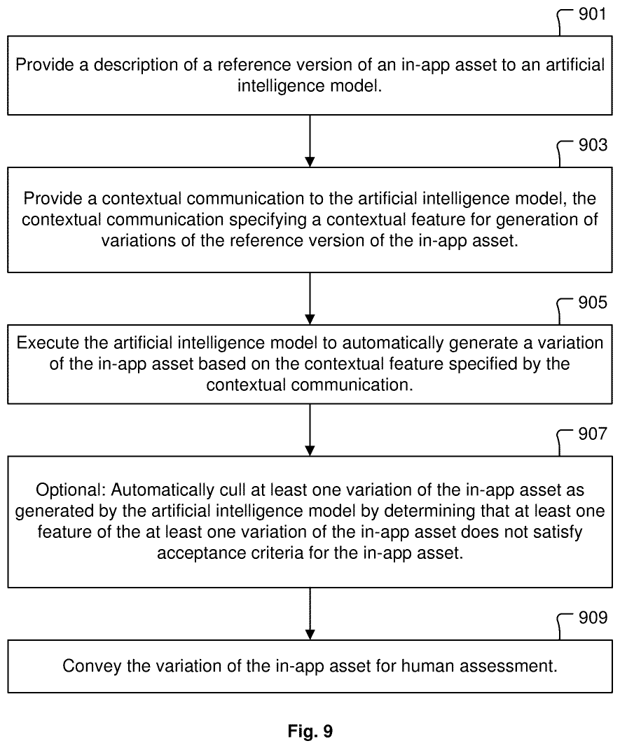

FIG. 9 shows a flowchart of a method for automatically generating a variation of an in-app asset, in accordance with some embodiments. In some embodiments, the in-app asset is an audio asset. In some embodiments, the in-app asset is a graphical asset. The method includes an operation 901 for providing a description of a reference version of an in-app asset to the AI model 521. The method also includes an operation 903 for providing a contextual communication to the AI model 521. The contextual communication specifies a contextual feature for generation of variations of the reference version of the in-app asset. In some embodiments, the contextual communication provided in the operation 903 is one or more of a text input to the AI model 521 and a graphical input to the AI model 521. The method also includes an operation 905 for executing the AI model 521 to automatically generate a variation of the in-app asset based on the contextual feature specified by the contextual communication. The method also includes an operation 909 for conveying the variation of the in-app asset for human assessment. In some embodiments, the operation 909 includes rendering of the variation of the in-app asset through a graphical user interface. In some embodiments, the method includes an optional operation 907 for automatically culling at least one variation of the in-app asset as generated by the AI model 521 by determining that at least one feature of the at least one variation of the in-app asset does not satisfy acceptance criteria for the in-app asset. In some embodiments, the operation 907 is done before the variation of the in-app asset is conveyed for human assessment in the operation 909.

In some embodiments, the in-app asset is defined by multiple layers, where each of the multiple layers defines a different aspect of the in-app asset. In some embodiments, the variation of the in-app asset includes a same set of layers as the reference version of the in-app asset, and a layer of the variation of the in-app asset is defined differently than a corresponding layer of the reference version of the in-app asset. In some embodiments, the variation of the in-app asset includes a different set of layers as compared to a reference set of layers that define the reference version of the in-app asset. In some of these embodiments, the different set of layers includes more layers than the reference set of layers, or the different set of layers includes less layers than the reference set of layers, or the different set of layers includes one or more layers not present in the reference set of layers. In some embodiments, at least one layer in the different set of layers is defined differently than an equivalent layer in the reference set of layers.

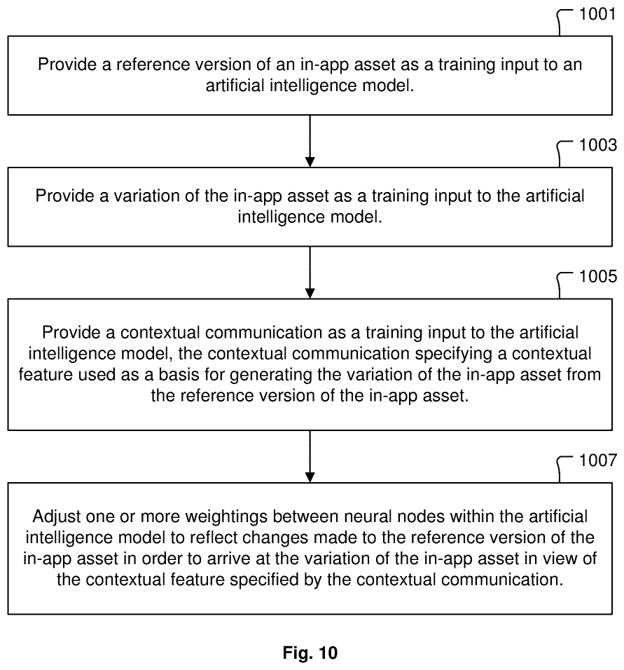

FIG. 10 shows a flowchart of a method for training the AI model 521 for generation of a variation of an in-app asset, in accordance with some embodiments. In some embodiments, the in-app asset is an audio asset. In some embodiments, the in-app asset is a graphical asset. The method includes an operation 1001 for providing a reference version of an in-app asset as a training input to the AI model 521. The method also includes an operation 1003 for providing a variation of the in-app asset as a training input to the AI model 521. The method also includes an operation 1005 for providing a contextual communication as a training input to the AI model 521. The contextual communication specifies a contextual feature used as a basis for generating the variation of the in-app asset from the reference version of the in-app asset. In some embodiments, the contextual feature is one or more of an audio input to the AI model 521 and a graphical input to the AI model 521. The method also includes an operation 1007 for adjusting one or more weightings between neural nodes within the AI model 521 to reflect changes made to the reference version of the in-app asset in order to arrive at the variation of the in-app asset in view of the contextual feature specified by the contextual communication. In some embodiments, the in-app asset is defined by multiple layers, where each of the multiple layers defines a different aspect of the in-app asset, and where the variation of the in-app asset includes a different set of layers as compared to a reference set of layers that define the reference version of the in-app asset and/or at least one different parameter setting within a layer common to both the reference version of the in-app asset and the variation of the in-app asset.

It should be appreciated that with the tool 507 disclosed herein, the trained AI model 521 can automatically generate variations on multi-layer in-app assets, which substantially reduces the time it takes for creators 501, such as game artists, to create many similar in-app assets. The AI-driven tool 507 speeds up the creation process and allows creators 501 to generate variations on sounds and/or graphics with more precision and control.

In some embodiments, the generation of an output image, graphics, and/or three-dimensional representation by an image generation AI (IGAI), can include one or more AI processing engines and/or models. In general, an AI model is generated using training data from a data set. The data set selected for training can be custom curated for specific desired outputs and in some cases the training data set can include wide ranging generic data that can be consumed from a multitude of sources over the Internet. By way of example, an IGAI should have access to a vast of amount of data, e.g., images, videos and three-dimensional data. The generic data is used by the IGAI to gain understanding of the type of content desired by an input. For instance, if the input is requesting the generation of a tiger in the Sahara desert, the data set should have various images of tigers and deserts to access and draw upon during the processing of an output image. The curated data set, on the other hand, maybe be more specific to a type of content, e.g., video game related art, videos and other asset related content. Even more specifically, the curated data set could include images related to specific scenes of a game or actions sequences including game assets, e.g., unique avatar characters and the like. As described above, an IGAI can be customized to enable entry of unique descriptive language statements to set a style for the requested output images or content. The descriptive language statements can be text or other sensory input, e.g., inertial sensor data, input speed, emphasis statements, and other data that can be formed into an input request. The IGAI can also be provided images, videos, or sets of images to define the context of an input request. In some embodiments, the input can be text describing a desired output along with an image or images to convey the desired contextual scene being requested as the output.

In some embodiments, an IGAI is provided to enable text-to-image generation. Image generation is configured to implement latent diffusion processing, in a latent space, to synthesize the text to image processing. In some embodiments, a conditioning process assists in shaping the output toward a desired target output using structured metadata. The structured metadata may include information gained from the user input to guide a machine learning model to denoise progressively in stages using cross-attention until the processed denoising is decoded back to a pixel space. In the decoding stage, upscaling is applied to achieve an image, video, or 3D asset that is of higher quality. The IGAI is therefore a custom tool that is engineered to processing specific types of input and render specific types of outputs. When the IGAI is customized, the machine learning and deep learning algorithms are tuned to achieve specific custom outputs, e.g., such as unique image assets to be used in gaming technology, specific game titles, and/or movies.

In another configuration, the IGAI can be a third-party processor, e.g., such as one provided by Stable Diffusion or others, such as OpenAI's GLIDE, DALL-E, MidJourney or Imagen. In some configurations, the IGAI can be used online via one or more Application Programming Interface (API) calls. It should be understood that reference to available IGAI is only for informational reference. For additional information related to IGAI technology, reference may be made to a paper published by Ludwig Maximilian University of Munich entitled “High-Resolution Image Synthesis with Latent Diffusion Models”, by Robin Rombach, et al., pp. 1-45. This paper is incorporated by reference.

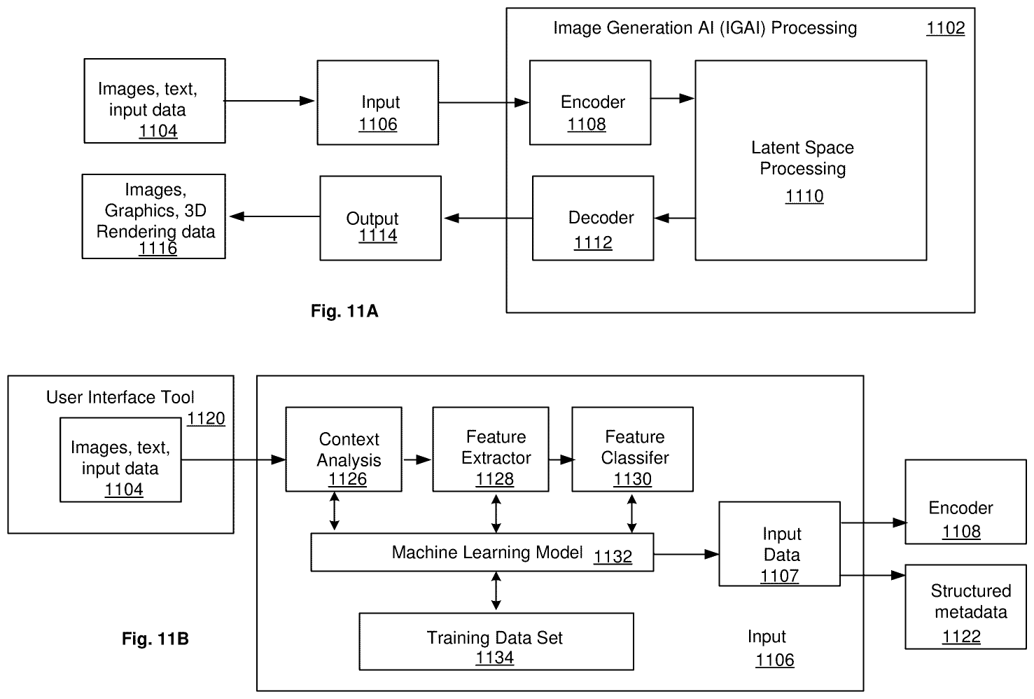

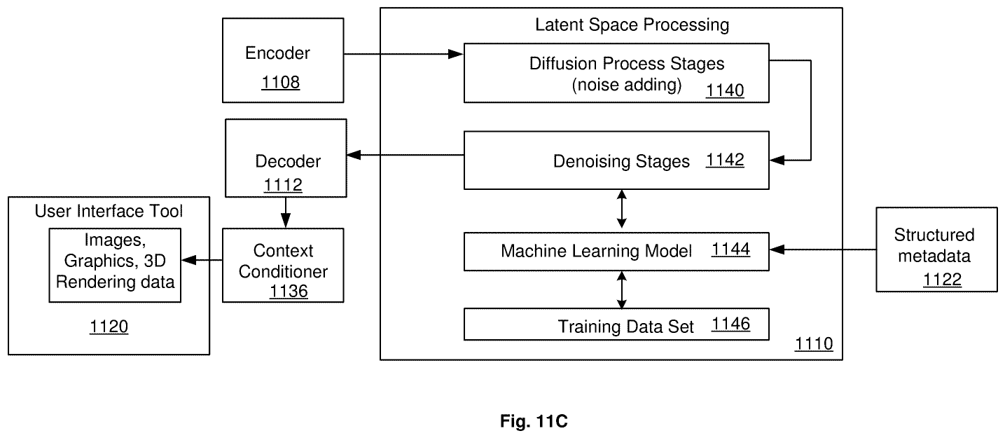

FIG. 11A is a general representation of an image generation AI (IGAI) 1102 processing sequence, in accordance with some embodiments. As shown, input 1106 is configured to receive input in the form of data, e.g., text description having semantic description or key words. The text description can in the form of a sentence, e.g., having at least a noun and a verb. The text description can also be in the form of a fragment or simply one word. The text can also be in the form of multiple sentences, which describe a scene or some action or some characteristic. In some configuration, the input text can also be input in a specific order so as to influence the focus on one word over others or even deemphasize words, letters or statements. Still further, the text input can be in any form, including characters, emojis, ions, foreign language characters (e.g., Japanese, Chinese, Korean, etc.). In some embodiments, text description is enabled by contrastive learning. The basic idea is to embed both an image and text in a latent space so that text corresponding to an images maps to the same area in the latent space as the image. This abstracts out the structure of what it means to be a dog for instance from both the visual and textual representation. In some embodiments, a goal of contrastive representation learning is to learn an embedding space in which similar sample pairs stay close to each other while dissimilar ones are far apart. Contrastive learning can be applied to both supervised and unsupervised settings. When working with unsupervised data, contrastive learning is one of the most powerful approaches in self-supervised learning.

In addition to text, the input can also include other content, e.g., such as images or even images that have descriptive content themselves. Images can be interpreted using image analysis to identify objects, colors, intent, characteristics, shades, textures, three-dimensional representations, depth data, and combinations thereof. Broadly speaking, the input 1106 is configured to convey the intent of the user that wishes to utilize the IGAI to generate some digital content. In the context of game technology, the target content to be generated can be a game asset for use in a specific game scene. In such a scenario, the data set used to train the IGAI and input 1106 can be used to customized the way AI, e.g., deep neural networks, process the data to steer and tune the desired output image, data or three-dimensional digital asset.

The input 1106 is then passed to the IGAI, where an encoder 1108 takes input data and/or pixel space data and coverts into latent space data. The concept of “latent space” is at the core of deep learning, since feature data is reduced to simplified data representations for the purpose of finding patterns and using the patterns. The latent space processing 1110 is therefore executed on compressed data, which significantly reduces the processing overhead as compared to processing learning algorithms in the pixel space, which is much more heavy and would require significantly more processing power and time to analyze and produce a desired image. The latent space is simply a representation of compressed data in which similar data points are closer together in space. In the latent space, the processing is configured to learn relationships between learned data points that a machine learning system has been able to derive from the information that it gets fed, e.g., the data set used to train the IGAI. In latent space processing 1110, a diffusion process is computed using diffusion models. Latent diffusion models rely on autoencoders to learn lower-dimension representations of a pixel space. The latent representation is passed through the diffusion process to add noise at each step, e.g., multiple stages. Then, the output is fed into a denoising network based on a U-Net architecture that has cross-attention layers. A conditioning process is also applied to guide a machine learning model to remove noise and arrive at an image that closely represents what was requested via user input. A decoder 1112 then transforms a resulting output from the latent space back to the pixel space. The output 1114 may then be processed to improve the resolution. The output 1114 is then passed out as the result, which may be an image, graphics, 3D data, or data that can be rendered to a physical form or digital form.

FIG. 11B illustrates additional processing that may be done to the input 1106, in accordance with some embodiments. A user interface tool 1120 may be used to enable a user to provide an input request 1104. The input request 1104, as discussed above, may be images, text, structured text, or generally data. In some embodiments, before the input request 1104 is provided to the encoder 1108, the input can be processed by a machine learning process that generates a machine learning model 1132, and learns from a training data set 1134. By way of example, the input data maybe be processed to via a context analyzer 1126 to understand the context of the request. For example, if the input is “space rockets for flying to the mars”, the input can be analyzed 1126 to determine that the context is related to outer space and planets. The context analysis may use machine learning model 1132 and training data set 1134 to find related images for this context or identify specific libraries of art, images or video. If the input request also includes an image of a rocket, the feature extractor 1128 can function to automatically identify feature characteristics in the rocket image, e.g., fuel tank, length, color, position, edges, lettering, flames, etc. A feature classifier 1130 can also be used to classify the features and improve the machine learning model 1132. In some embodiments, the input data 1107 can be generated to produce structured information that can be encoded by encoder 1108 into the latent space. Additionally, it is possible to extract out structured metadata 1122 from the input request. The structed metadata 1122 may be, for example, descriptive text used to instruct the IGAI 1102 to make a modification to a characteristic or change to the input images or changes to colors, textures, or combinations thereof. For example, the input request 1104 could include an image of the rocket, and the text can say “make the rocket wider” or “add more flames” or “make it stronger” or some of other modifier intended by the user (e.g., semantically provided and context analyzed). The structured metadata 1122 can then be used in subsequent latent space processing to tune the output to move toward the user's intent. In one embodiment, the structured metadata may be in the form of semantic maps, text, images, or data that is engineered to represent the user's intent as to what changes or modifications should be made an input image or content.

FIG. 11C illustrates how the output of the encoder 1108 is then fed into latent space processing 1110, in accordance with some embodiments. A diffusion process is executed by diffusion process stages 1140, where the input is processed through a number of stages to add noise to the input image or images associated with the input text. This is a progressive process, where at each stage, e.g., 10-50 or more stages, noise is added. Next, a denoising process is executed through denoising stages 1142. Similar to the noise stages, a reverse process is executed where noise is removed progressively at each stage, and at each stage, machine learning is used to predict what the output image or content should be, in light of the input request intent. In one embodiment, the structured metadata 1122 can be used by a machine learning model 1144 at each stage of denoising, to predict how the resulting denoised image should look and how it should be modified. During these predictions, the machine learning model 1144 uses the training data set 1146 and the structured metadata 1122, to move closer and closer to an output that most resembles the requested in the input. In some embodiments, during the denoising, a U-Net architecture that has cross-attention layers may be used, to improve the predictions. After the final denoising stage, the output is provided to a decoder 1112 that transforms that output to the pixel space. In some embodiments, the output is also upscaled to improve the resolution. The output of the decoder, in some embodiments, can be optionally run through a context conditioner 1136. The context conditioner 1136 is a process that may use machine learning to examine the resulting output to make adjustments to make the output more realistic or remove unreal or unnatural outputs. For example, if the input asks for “a boy pushing a lawnmower” and the output shows a boy with three legs, then the context conditioner 1136 can make adjustments with in-painting processes or overlays to correct or block the inconsistent or undesired outputs. However, as the machine learning model 1144 gets smarter with more training over time, there will be less need for a context conditioner 1136 before the output is rendered in the user interface tool 1120.

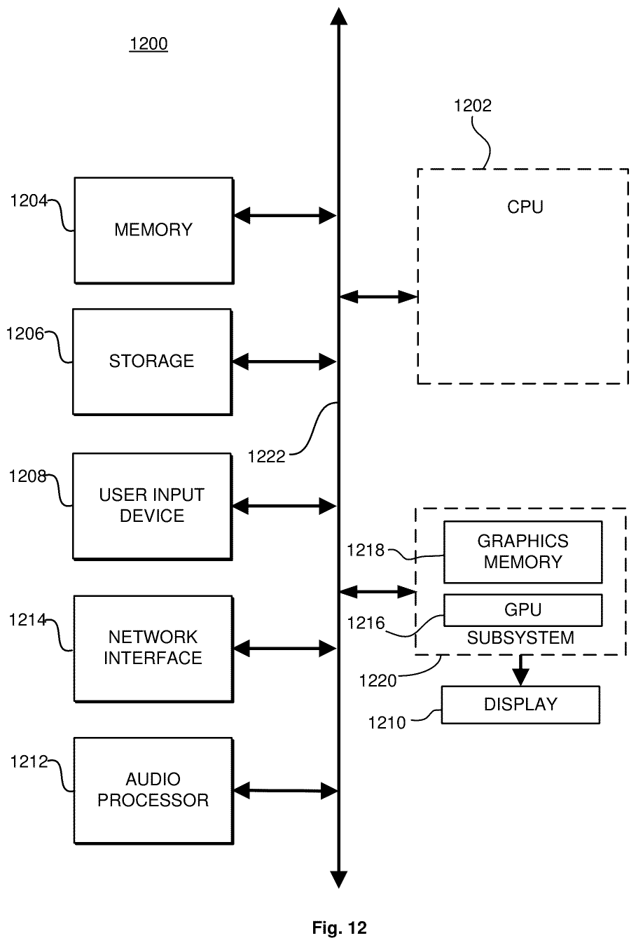

FIG. 12 illustrates components of an example server device 1200 within a cloud-based computing system that can be used to perform aspects of the tool 507, in accordance with some embodiments. This block diagram illustrates the server device 1200 that can incorporate or can be a personal computer, video game console, personal digital assistant, a head mounted display (HMD), a wearable computing device, a laptop or desktop computing device, a server or any other digital computing device, suitable for practicing an embodiment of the disclosure. The server device (or simply referred to as “server” or “device”) 1200 includes a central processing unit (CPU) 1202 for running software applications and optionally an operating system. CPU 1202 may be comprised of one or more homogeneous or heterogeneous processing cores. For example, CPU 1202 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 1200 may be localized to a player playing a game segment (e.g., game console), or remote from the player (e.g., back-end server processor), or one of many servers using virtualization in the cloud-based gaming system 1200 for remote streaming of game play to client devices.

Memory 1204 stores applications and data for use by the CPU 1202. Storage 1206 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 1208 communicate user inputs from one or more users to device 1200, examples of which may include keyboards, mice, joysticks, touch pads, touch screens, still or video recorders/cameras, tracking devices for recognizing gestures, and/or microphones. Network interface 1214 allows device 1200 to communicate with other computer systems via an electronic communications network, and may include wired or wireless communication over local area networks and wide area networks such as the internet. An audio processor 1212 is adapted to generate analog or digital audio output from instructions and/or data provided by the CPU 1202, memory 1204, and/or storage 1206. The components of device 1200, including CPU 1202, memory 1204, data storage 1206, user input devices 1208, network interface 1214, and audio processor 1212 are connected via one or more data buses 1222.

A graphics subsystem 1220 is further connected with data bus 1222 and the components of the device 1200. The graphics subsystem 1220 includes a graphics processing unit (GPU) 1216 and graphics memory 1218. Graphics memory 1218 includes a display memory (e.g., a frame buffer) used for storing pixel data for each pixel of an output image. Graphics memory 1218 can be integrated in the same device as GPU 1216, connected as a separate device with GPU 1216, and/or implemented within memory 1204. Pixel data can be provided to graphics memory 1218 directly from the CPU 1202. Alternatively, CPU 1202 provides the GPU 1216 with data and/or instructions defining the desired output images, from which the GPU 1216 generates the pixel data of one or more output images. The data and/or instructions defining the desired output images can be stored in memory 1204 and/or graphics memory 1218. In an embodiment, the GPU 1216 includes 3D rendering capabilities for generating pixel data for output images from instructions and data defining the geometry, lighting, shading, texturing, motion, and/or camera parameters for a scene. The GPU 1216 can further include one or more programmable execution units capable of executing shader programs.

The graphics subsystem 1220 periodically outputs pixel data for an image from graphics memory 1218 to be displayed on display device 1210. Display device 1210 can be any device capable of displaying visual information in response to a signal from the device 1200, including CRT, LCD, plasma, and OLED displays. In addition to display device 1210, the pixel data can be projected onto a projection surface. Device 1200 can provide the display device 1210 with an analog or digital signal, for example.

Implementations of the present disclosure for communicating between computing devices may be practiced using various computer device configurations including hand-held devices, microprocessor systems, microprocessor-based or programmable consumer electronics, minicomputers, mainframe computers, head-mounted display, wearable computing devices and the like. Embodiments of the present disclosure can also be practiced in distributed computing environments where tasks are performed by remote processing devices that are linked through a wire-based or wireless network.

In some embodiments, communication may be facilitated using wireless technologies. Such technologies may include, for example, 5G wireless communication technologies. 5G is the fifth generation of cellular network technology. 5G networks are digital cellular networks, in which the service area covered by providers is divided into small geographical areas called cells. Analog signals representing sounds and images are digitized in the telephone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a pool of frequencies that are reused in other cells. The local antennas are connected with the telephone network and the Internet by a high bandwidth optical fiber or wireless backhaul connection. As in other cell networks, a mobile device crossing from one cell to another is automatically transferred to the new cell. It should be understood that 5G networks are just an example type of communication network, and embodiments of the disclosure may utilize earlier generation wireless or wired communication, as well as later generation wired or wireless technologies that come after 5G.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing.

One or more embodiments can also be fabricated as computer readable code (program instructions) on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

1. A method for automatically generating a variation of an in-app asset, comprising:
providing a description of a reference version of an in-app asset to an artificial intelligence model;
providing a contextual communication to the artificial intelligence model, the contextual communication specifying a contextual feature for generation of variations of the reference version of the in-app asset;
executing the artificial intelligence model to automatically generate a variation of the in-app asset based on the contextual feature specified by the contextual communication; and
conveying the variation of the in-app asset for human assessment.

2. The method as recited in claim 1, wherein the in-app asset is defined by multiple layers, wherein each of the multiple layers defines a different aspect of the in-app asset.

3. The method as recited in claim 1, wherein the variation of the in-app asset includes a same set of layers as the reference version of the in-app asset, and wherein a layer of the variation of the in-app asset is defined differently than a corresponding layer of the reference version of the in-app asset.

4. The method as recited in claim 1, wherein the variation of the in-app asset includes a different set of layers as compared to a reference set of layers that define the reference version of the in-app asset.

5. The method as recited in claim 4, wherein the different set of layers includes more layers than the reference set of layers, or wherein the different set of layers includes less layers than the reference set of layers, or wherein the different set of layers includes one or more layers not present in the reference set of layers.

6. The method as recited in claim 5, wherein at least one layer in the different set of layers is defined differently than an equivalent layer in the reference set of layers.

7. The method as recited in claim 1, wherein the contextual communication is one or more of a text input to the artificial intelligence model and a graphical input to the artificial intelligence model.

8. The method as recited in claim 1, wherein conveying the variation of the in-app asset for human assessment includes rendering of the variation of the in-app asset through a graphical user interface.

9. The method as recited in claim 1, wherein the in-app asset is an audio asset.

10. The method as recited in claim 1, wherein the in-app asset is a graphical asset.

11. The method as recited in claim 1, further comprising:
automatically culling at least one variation of the in-app asset as generated by the artificial intelligence model by determining that at least one feature of the at least one variation of the in-app asset does not satisfy acceptance criteria for the in-app asset.

12. A method for training an artificial intelligence model for generation of a variation of an in-app asset, comprising:
providing a reference version of an in-app asset as a training input to an artificial intelligence model;
providing a variation of the in-app asset as a training input to the artificial intelligence model;
providing a contextual communication as a training input to the artificial intelligence model, the contextual communication specifying a contextual feature used as a basis for generating the variation of the in-app asset from the reference version of the in-app asset; and
adjusting one or more weightings between neural nodes within the artificial intelligence model to reflect changes made to the reference version of the in-app asset in order to arrive at the variation of the in-app asset in view of the contextual feature specified by the contextual communication.

13. The method as recited in claim 12, wherein the contextual feature is one or more of an audio input to the artificial intelligence model and a graphical input to the artificial intelligence model.

14. The method as recited in claim 12, wherein the in-app asset is defined by multiple layers, wherein each of the multiple layers defines a different aspect of the in-app asset, wherein the variation of the in-app asset includes a different set of layers as compared to a reference set of layers that define the reference version of the in-app asset and/or at least one different parameter setting within a layer common to both the reference version of the in-app asset and the variation of the in-app asset.

15. The method as recited in claim 12, wherein the in-app asset is an audio asset.

16. The method as recited in claim 12, wherein the in-app asset is a graphical asset.

17. A system for automatically generating and auditioning variations of an in-app asset, comprising:
an input processor configured to receive a reference version of an in-app asset and a contextual communication, the contextual communication specifying a contextual feature for generation of variations of the reference version of the in-app asset;
an artificial intelligence model configured to receive the reference version of the in-app asset and the contextual communication as input and automatically generate a variation of the in-app asset based on the reference version of the in-app asset and the contextual communication; and
an output processor configured to convey the variation of the in-app asset to a client computing system.

18. The system as recited in claim 17, wherein the in-app asset is defined by multiple layers, wherein each of the multiple layers defines a different aspect of the in-app asset, wherein the variation of the in-app asset includes a different set of layers as compared to a reference set of layers that define the reference version of the in-app asset and/or at least one different parameter setting within a layer common to both the reference version of the in-app asset and the variation of the in-app asset.

19. The system as recited in claim 17, further comprising:
a graphical user interface executed at the client computing system to provide for rendering and assessment of the variation of the in-app asset.

20. The system as recited in claim 17, wherein the in-app asset is either an audio asset or a graphical asset.
